(19) United States
(12) Patent Application Publication
(10) Pub. No.: US 2008/0087225 A1
(43) Pub. Date: Apr. 17, 2008

(54) Hummingbird feeder

(76) Inventor: Ling-Yung Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/546,292

(22) Filed: Oct. 12, 2006

(51) Int. Cl. A01K 7/00

(52) U.S. Cl. 119/72

(57) ABSTRACT

A hummingbird feeder comprised of a reservoir, a hollow feeding tube, and a detachable stopper. The reservoir has an opening disposed on a top end thereof. The hollow feeding tube has a head portion and a shaft portion extending from the head portion. The head portion has a plurality of holes disposed thereon. The diameter of the head portion is larger than that of the shaft portion. The detachable stopper is separately disposed on the opening and has a first aperture. The first aperture cooperates with the shaft portion for holding the shaft portion and receiving the reservoir within.

### BACKGROUND OF THE INVENTION

1. Field of the Invention

The present invention relates to a hummingbird feeder, and more especially to a hummingbird feeder wherein the length of the feeding tube is undefined and a plurality of holes formed therein to prevent the insects from absorbing a liquid receiving in the reservoir.

2. Description of Related Art

In general, hummingbirds have a fast breathing rate, a fast heartbeat, and a high body temperature. As a result, they must feed every ten minutes or so throughout the day, and consume as much as two-thirds of their total body weight in a single day. While they eat both nectar and insects, about a third of a hummingbird's diet is sugar, which is obtained from the nectar of flowers and tree sap.

Hummingbirds have bills that are long and tapered, perfectly suited for probing into the center of tubular flowers, such as trumpet vines, for the nectar. A hummingbird's tongue is approximately one and one-half times the length of its bill, tube-like in nature, and is used to dart deep into the flowers for nectar, taking up liquid via a capillary action.

Hummingbird feeders which are found in the marketplace today attempt to replicate the flower feeding experience for a hummingbird. Feeders are made which hang vertically with feeder tubes extending downward. Other feeders are comprised of horizontal, hanging reservoirs with feeding tubes emanating therefrom. These feeding tubes often replicate flower blossoms and are colored in nature in order to attract the hummingbirds.

However, these traditional feeding tubes, suffer some problems as are described below:

Firstly, the tubes, do not replicate or encourage a true feeding experience for hummingbirds. The stem of a typical feeding tube does not extend to the full length of a hummingbird's bill. The proportional dimensions of the feeding tube's diameter and length are not realistic. Consequently, when a hummingbird places its bill in such a stem, its tongue extends well beyond the stem. Thereby, negating the capillary action of the tongue and failing to replicate the sensation of feeding from a flower.

As a result, these types of feeding tubes are not as effective for encouraging the feeding of hummingbirds.

Secondly, due to the shortness of the stem, the feeder becomes ineffective once the fluid contained therein falls below the bottom of the stem. Once this has occurred, whenever a hummingbird inserts its tongue past the stem it makes contact with air rather than fluid.

As a result, the hummingbird believes that there is no more “nectar” in the feeder and leaves, even though this is not the case. The remaining fluid is therefore not used and goes to waste. While feeding tubes exist that are longer in nature, they are typically used in conjunction with downward-facing hummingbird feeders and are not inserted into the reservoir itself. Rather, they are suspended from the orifice of the reservoir.

This configuration does not suffer the problem of having fluid go to waste because gravity continually draws fluid into the tube. However, the fluid leaking out and attracting annoying insects, such as wasps, bees, and ants, is problematic with this type of inverted feeder tube.

Thirdly, because typical feeder tubes do not substantially extend into the feeder reservoir, insects with short tongues, such as bees, are encouraged to feed on the “nectar”, thereby depleting the amount left for hummingbirds. A narrower, longer tube would discourage insects from attempting to steal “nectar” from these feeders.

### SUMMARY OF THE INVENTION

The primary object of the present invention is to provide a hummingbird feeder wherein the length of the feeding tube is undefined.

A further object of the present invention is to provide a hummingbird feeder which efficiently utilizes the fluid contained in the reservoir of the hummingbird feeder.

Another further object of the present invention is to provide a hummingbird feeder which is a more realistic feeding tube adapted for use with a hummingbird feeding reservoir in order to encourage a larger amount of hummingbird feeding activity.

In order to achieve the above objects, the present invention provides a hummingbird feeder, which comprises: a reservoir, a hollow feeding tube and a detachable stopper, wherein the reservoir has an opening disposed on a top end thereof, the hollow feeding tube has a head portion and a shaft portion extending from the head portion, wherein the head portion has a plurality of holes disposed thereon, the diameter of the head portion is larger than that of the shaft portion, a detachable stopper is separately disposed on the opening and has a first aperture, and the first aperture cooperates with the shaft portion for holding the shaft portion and receiving the reservoir within.

This configuration more closely replicates a hummingbird's feeding experience with a trumpet vine blossom. Because of a hummingbird's ability to extend its tongue well beyond its bill, it is critical that the tongue be given the proper receptor in order to facilitate its capillary action. Moreover, shorter versions of the feeding tube allow a hummingbird's tongue to wander freely, which negates this capillary action, thereby impeding a hummingbird's ability to feed.

Beside, the holes formed on the head portion of the feeding tube can prevent the insects (such as the honeybees, the ants or the butterflies) from absorbing the liquid accommodated in the reservoir.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawing, in which:

FIG. 1 is a perspective view of the first embodiment of the present invention;

FIG. 2 is an exploded perspective view of the first embodiment of the present invention;

FIG. 3 is a perspective view of the second embodiment of the present invention; and

FIG. 4 is an exploded perspective view of the second embodiment of the present invention.

### DETAILED DESCRIPTION OF PREFERRED EMBODIMENTS

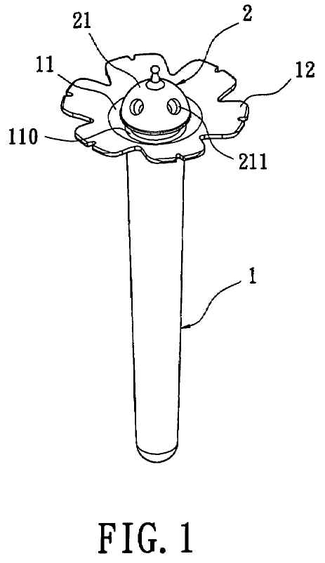

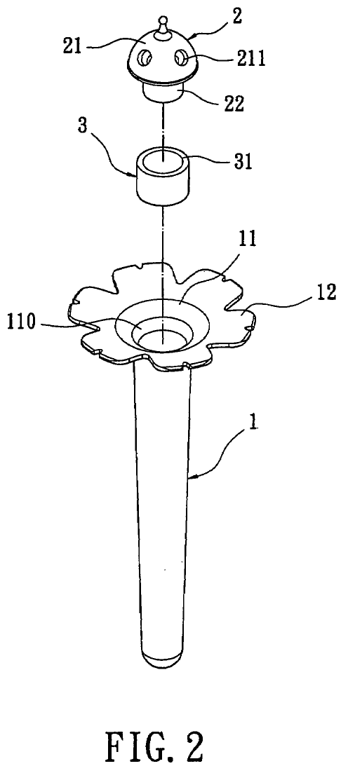

Referring to FIGS. 1 and 2, which show the first embodiment of the present invention, the hummingbird feeder comprises a reservoir 1, a hollow feeding tube 2, and a detachable stopper 3. The reservoir 1 has an opening 11 which is arranged on the top end of the reservoir 1. The hollow feeding tube 2 has a head portion 21 and a shaft portion 22 which extends from the head portion 21. The head portion 21 has a plurality of holes 211 which are arranged on the head portion 21, wherein a diameter of the head portion 21 is larger than that of the shaft portion 22. The detachable stopper 3 is separately arranged on the opening 11 and the detachable stopper 3 has a first aperture 31. The first aperture 31 cooperates with the shaft portion 22 in order to hold the shaft portion 22 and receive the reservoir 1 within. Thereby, the reservoir 1 may be provided in combination with the feeding tube 2 freely.

In the first embodiment of the present invention, the reservoir 1 has a plurality of petals 12 which extend outwardly from an edge of the opening 11 (in the first embodiment, the quantity of petals is six); wherein the opening 11 has a second aperture 110 for holding the detachable stopper 3. The reservoir 1 receives a liquid and a hummingbird can lick the liquid through the holes 211 of the feeding tube 2. Moreover, the holes 211 can prevent the insects (such as honey bee, ant, or butterfly) from absorbing the liquid (not shown) which are accommodated in the reservoir 1. The feeding tube 2 can be made of glass, plastic, or various compositions of resin. The stopper 3 can be made of plastic.

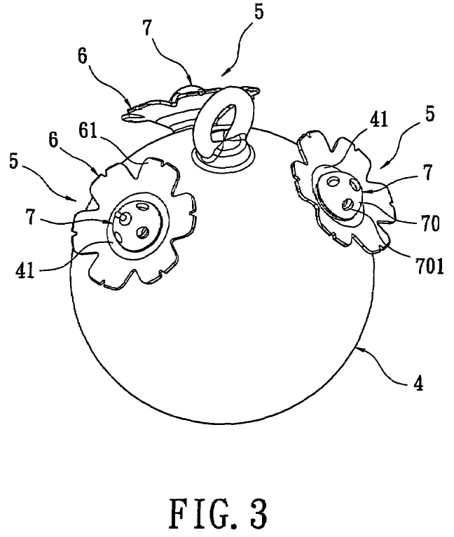

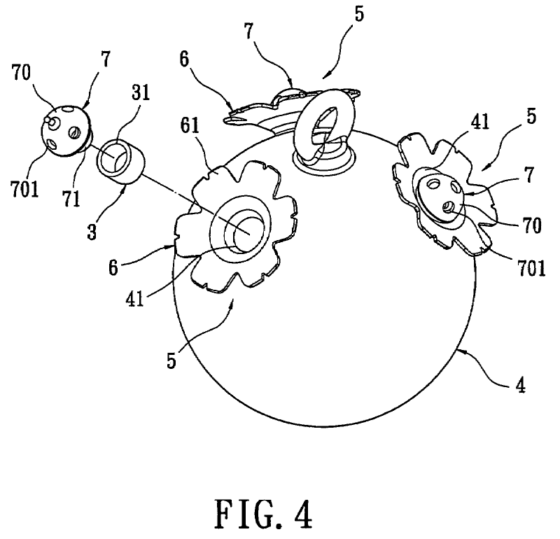

Referring to FIGS. 3 and 4, which show the second embodiment of the present invention, the hummingbird feeder comprises of a reservoir 4 and a plurality of detachable feeding devices 5. The reservoir 4 has a plurality of openings 41 which are arranged on a top end of the reservoir 4. The detachable feeding devices 5 are arranged on the openings 41 separately. Each feeding device 5 has a cover 6, a detachable stopper 3 and a feeding tube 7 which is arranged within each of the covers 6. Each cover 6 can be installed on each opening 41 of the reservoir 4 fixedly. Each stopper 3 has a first aperture 31. Each feeding tube 7 has a head portion 70 and a shaft portion 71 which extends from the head portion 70. The head portion 70 has a plurality of holes 701 arranged on the portion 70. A diameter of the head portion 70 is larger than that of the shaft portion 71, the shaft portion 71 can cooperate with the first aperture 31 of the stopper 3 so that the shaft portion 71 is received within the reservoir 4. Thereby, the reservoir 4 may be provided in combination with the feeding devices 5 freely.

In the second embodiment of the present invention, both the cover 6 and the feeding tube 7 of each feeding device 5 are formed integrally. Each cover 6 has a plurality of petals 61 extending from the bottom of the cover 6 to the top of the cover 6 (in the second embodiment, the quantity of petals is six). The reservoir 4 receives a liquid wherein a hummingbird can lick the liquid through the holes 701 of the feeding tube 7. The holes 701 can prevent the insects from absorbing the liquid (not shown) which are accommodated in the reservoir 4 The feeding tube 7 can be made of glass, plastic, or various compositions of resin.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A hummingbird feeder, comprising:
a reservoir having an opening disposed on a top end thereof;
a hollow feeding tube having a head portion and a shaft portion extending from the head portion, wherein the head portion has a plurality of holes disposed thereon, and a diameter of the head portion is larger than that of the shaft portion; and
a detachable stopper separately disposed on the opening and having a first aperture, wherein the first aperture cooperates with the shaft portion for holding the shaft portion and receiving the reservoir within.

2. The hummingbird feeder as claimed in claim 1, wherein the reservoir has a plurality of petals extending outwardly from an edge of the opening.

3. The hummingbird feeder as claimed in claim 1, wherein the opening has a second aperture for holding the detachable stopper.

4. The hummingbird feeder as claimed in claim 1, wherein the reservoir receives a liquid, wherein the liquid is licked by a hummingbird through the holes of the feeding tube.

5. The hummingbird feeder as claimed in claim 1, wherein the holes formed on the head portion can prevent the insects from absorbing a liquid receiving in the reservoir.

6. The hummingbird feeder as claimed in claim 1, wherein the feeding tube is made of glass.

7. The hummingbird feeder as claimed in claim 1, wherein the feeding tube is made of plastic.

8. The hummingbird feeder as claimed in claim 1, wherein the stopper is made of plastic.

9. A hummingbird feeder, comprising:
a reservoir having a plurality of openings disposed on a top end thereof; and
a plurality of detachable feeding devices disposed on the openings separately, each feeding device having a cover with an aperture and a hollow feeding tube disposed on the aperture of the cover, each feeding tube having a head portion and a shaft portion extended from the head portion, wherein the head portion has a plurality of holes disposed thereon, a diameter of the head portion is larger than that of the shaft portion, and the shaft portion is received within the reservoir.

10. The hummingbird feeder as claimed in claim 9, wherein the cover and the feeding tube for each feeding device is constructed integrally.

11. The hummingbird feeder as claimed in claim 9, wherein each cover has a plurality of petals extending from a bottom to a top thereof.

12. The hummingbird feeder as claimed in claim 9, wherein the reservoir receives a liquid, wherein the liquid is licked by a hummingbird through the holes of the feeding tube.

13. The hummingbird feeder as claimed in claim 9, wherein the holes formed on the head portion can prevent the insects from absorbing a liquid receiving in the reservoir.

14. The hummingbird feeder as claimed in claim 9, wherein each feeding device is comprised of glass.

15. The hummingbird feeder as claimed in claim 9, wherein each feeding device is comprised of plastic.

16. A hummingbird feeder, comprising:
a hollow feeding tube having a head portion and a shaft portion extending from the head portion, the head portion having at least one hole disposed thereon and a first diameter, the shaft portion having a second diameter, wherein the first diameter is larger than the second diameter;
a reservoir having an opening disposed on a top end thereof; and
a detachable stopper having an external diameter and an internal diameter, the external diameter cooperates with the opening of the reservoir so that the stopper is arranged on the opening separately, the internal diameter cooperates with the second diameter of the shaft portion in order to hold the shaft portion and receive the reservoir within.

17. The hummingbird feeder as claimed in claim 16, wherein the reservoir has a plurality of petals extending outward from an edge of the opening.

18. The hummingbird feeder as claimed in claim 16, wherein the opening has a third diameter for holding the external diameter of the detachable stopper.

19. The hummingbird feeder as claimed in claim 16, wherein the reservoir receives a liquid, wherein the liquid is licked by a hummingbird through the holes of the feeding tube.

20. The hummingbird feeder as claimed in claim 16, wherein the hole formed on the head portion can prevent the insects from absorbing a liquid receiving in the reservoir.
